(19) United States
(12) Patent Application Publication
(10) Pub. No.: US 2022/0248681 A1
(43) Pub. Date: Aug. 11, 2022

(54) Control of control of metabolite production in Plants By Simultaneous Injection With CO2 and O2

(71) Applicant: CO2Gro, Inc., Toronto (CA)

(72) Inventors: John H. Archibald, Grimsby (CA); Matthew Julius, Sauk Rapids, MN (US)

(21) Appl. No.: 17/620,041

(22) PCT Filed: Jun. 21, 2019
(86) PCT No.: PCT/CA2019/050870

§ 371 Date: Dec. 16, 2021

(51) Int. Cl. A01N 59/04; A01N 59/00; A01G 7/02; A01G 29/00

(52) U.S. Cl. CPC A01N 59/04; A01G 29/00; A01G 7/02; A01N 59/00

(57) ABSTRACT

As part of the natural biological process, plants produce various metabolites. The amount of certain metabolites produced is important, especially during the growth phase of plants to be harvested in whole or in part. The production of metabolites is affected by the chemical environment within the plant, including the amount of CO₂ and O₂. The production of metabolites of interest can be controlled by measuring the amount of the metabolites being produced by the plant, and then adjusting the amount of CO₂ and O₂ available to the plant. These are adjusted by adjusting the amount of CO₂ in water delivered to the leaves of the plant through foliar spraying and the amount of O₂ in water delivered to the roots of the plant.

### FIELD OF INVENTION

This invention relates to agriculture, and more particularly to control of metabolite production in growing plants.

### BACKGROUND

Metabolites are chemical compounds that are the end products of metabolism. They are used by the organism for a number of purposes, including but not limited to growth, development, and reproduction of the organism. For example, ethylene is produced by plant cells to regulate metabolism. If there is insufficient respiration by the plant to process all the carbon, normally available through atmospheric CO₂, then the plant produces more ethylene which in turn slows the metabolism of the plant.

Some metabolites are also used promote propagation, such as by making fruit more nutritionally valuable to seed spreaders. Examples are vitamin C in oranges and oil content in avocados. Promotion of the production of these metabolites is clearly of value to human beings and agriculture. Promotion of production of metabolites that have pharmaceutical value or industrial value is of value as well. Even metabolites that merely promote healthy growth of a plant as a whole or of parts of a plant may be of interest to humans, as more calories can be made available to a growing population.

Metabolite production is affected by the chemical environment in which the metabolite is produced. In the example of ethylene given above, the amount of ethylene produced by cells of the plant depends on how much oxygen is available to the cells.

It would be desirable to optimize metabolite production in plants by affecting the chemical environment within the plant. It would be particularly desirable for such a method to be effective with most or all higher leafy plants.

### SUMMARY

According to one embodiment of the invention, a method of controlling metabolite production in a crop of plants of a species is provided. CO₂-infused water is delivered to leaves of all plants within the crop by foliar spraying. O₂-infused water is delivered to roots of all plants within the crop by root feeding the plants. An amount of a particular metabolite is measured within a subset of at least one plant of the crop. If the amount of the particular metabolite is not within the target range, then the amount of CO₂ being infused into the CO₂-infused water is adjusted and the amount of O₂ being infused into the O₂-infused water is adjusted. The delivering of CO₂ and O₂, the measuring of the amount of metabolite, and adjusting the amount of CO₂ and O₂ if necessary is repeated intermittently until the crop is harvested or until the plants in the crop reach the end of their life cycle.

The metabolite may be measured directly or indirectly. If measured indirectly, then an amount of mRNA associated with production of the metabolite is measured.

The methods of the present invention are effective with virtually all photosynthetic plant species having leaves or other surfaces capable of receiving foliar sprays, particularly higher plants. “Higher” plants include all plant species having true stems, roots, and leaves, and thus exclude lower plants, e.g. yeasts, algae and molds.

The present invention provides substantial benefits in controlling the production of metabolites during the growth of a plant. Production of a particular metabolite during growth of the plant can be controlled by adjusting the amount of CO₂ and O₂ delivered to the leaves through foliar spraying with CO₂-infused water and to the roots through watering with O₂-infused water, respectively. This results in healthier plants, which may reduce spoilage, improve plant yield, and/or reduce growth time. This may also result in more of a particular metabolite which is of value to humans.

### DETAILED DESCRIPTION OF THE PREFERRED EMBODIMENTS

The method of the invention is applied to an entire crop of plants, as described below. However, for simplicity the invention will be described with reference to a single plant.

The amount of a particular metabolite in a plant is measured, either directly or indirectly. For some metabolites the amount of the metabolite may be measured directly by simple extraction of the fluid in a cell and measuring the amount of metabolite. Such direct measurement would be appropriate for vitamin C or oil, for example. Other metabolites, particularly some exotic proteins, do not lend themselves to direct measurement. Instead, an indirect measurement of the amount of the metabolite must be made. Measurement of the amount of mRNA carrying instructions for producing the metabolite is made, for example using real-time polymerase chain reaction to quantify the amount of the particular mRNA present. As mRNA activity is directly correlated with production of the corresponding protein, an indirect measurement of the amount of the metabolite is possible.

A target range for the metabolite is selected. It is determined whether the measured amount of the metabolite is outside the target range. If the measured amount of the metabolite is not within the target range, then the amount of CO₂ and O₂ made available to the plant is adjusted simultaneously. CO₂ is made available to the plant through foliar spraying of the leaves of the plant with CO₂-infused water. The amount of CO₂ made available to the plant is adjusted by altering the amount of CO₂ being infused into the water. If more CO₂ is desired then the amount of CO₂ being infused into the water is increased, and if less CO₂ is desired then the amount of CO₂ being infused into the water is decreased. O₂ is made available to the plant through root feeding of the plant with O₂-infused water. The amount of O₂ made available to the plant is adjusted by altering the amount of O₂ being infused into the water. If more O₂ is desired then the amount of O₂ being infused into the water is increased, and if less O₂ is desired then the amount of O₂ being infused into the water is decreased.

The amount of CO₂ and O₂ adjustment will depend on the particular metabolite and may depend on the particular species of the plant. For example, suppose the metabolite of interest was ethylene. If extra CO₂ is delivered to the plant leaves to produce carbohydrates, respiration rates in the roots or shoot must increase to use this surplus carbohydrate. If respiration does not increase, ethylene is produced which slows the metabolism of the plant leaves. By controlling both CO₂ and O₂ supplies in the plant, ethylene production can be regulated. If the measured amount of ethylene is below a target range and more ethylene is desired, the amount of CO₂ made available to the plant is increased and the amount of O₂ made available to the plant is decreased so as to slow respiration. If the measured amount of ethylene is above the target range and less ethylene is desired, the amount of CO₂ made available to the plant is decreased and the amount of O₂ made available to the plant is increased so as to raise the respiratory rate and slow ethylene production. The changes in the amounts of CO₂ and O₂ are accomplished as set out above.

As another example, suppose the metabolite of interest was vitamin C in oranges. If the amount of vitamin C being produced is below a target range, then the amount of CO₂ being delivered to the plant is increased and the amount of O₂ being delivered to the plant is decreased. This triggers the production of excess vitamin C in oranges. The increase in CO₂ and the decrease in the amount of O₂ is accomplished as set out above. Since more than usual amounts of vitamin C is not usually a concern, the upper limit of the target range can be considered to be effectively infinite, or at least a very high number.

Measurement of production of the metabolite and possible adjustment of the CO₂ and O₂ levels is carried out throughout the life cycle of the plant or until harvest. The frequency of measurement of metabolite production depends on the plant species, but may be on the order of days or weeks.

As the invention involves the adjustment of CO₂ and O₂ levels, the metabolite of interest must be within the carbohydrate demand and respiration activity metabolic pathways. Non-limiting examples of such metabolites are ethylene, vitamin C, plant oil, THC, and CBD. However, within this constraint, the method of the invention is the same for all metabolites and all plant species. Specific parameters of the method are dependent on the particular metabolite and the plant species to which the invention is being applied. The plant species is a higher order photosynthetic plant species having leaves or other surfaces capable of receiving foliar sprays, particularly leafy green plants.

The invention has been described for simplicity with respect to a single plant. More practically, the method of the invention would be applied to a number of plants in a crop in order to produce statistically significant measures of the metabolite production. In such an embodiment, the metabolite levels of a subset of at least one plant within a crop of more than one plant of the same species would be measured intermittently, and for each set of measurements a statistical measure is taken. A very simple example would be to take the average of all measurements of metabolite production. Using the statistical measure, the CO₂ infused into the water used for foliar spraying and the O₂ infused into water used for feeding the roots is adjusted. Foliar spraying and root feeding of the entire crop with the CO₂-infused water and the O₂-infused water, respectively, would be carried out with the new amounts of CO₂ and O₂.

The embodiments presented are exemplary only and persons skilled in the art would appreciate that variations to the embodiments described above may be made without departing from the spirit of the invention. The scope of the invention is solely defined by the appended claims.

1. A method of controlling metabolite production in a crop of plants of a species, comprising:
(a) delivering CO₂-infused water to leaves of all plants within the crop by foliar spraying;
(b) delivering O₂-infused water to roots of all plants within the crop by root feeding the plants;
(c) measuring an amount of a particular metabolite within a subset of at least one plant of the crop;
(d) determining whether the amount of the particular metabolite is within a target range;
(e) if the amount of the particular metabolite is not within the target range:
adjusting the amount of CO₂ being infused into the CO₂-infused water; and
adjusting the amount of O₂ being infused into the O₂-infused water; and
(f) repeating steps (a)-(e) intermittently until the crop is harvested or until the plants in the crop reach the end of their life cycle.

2. The method of claim 1 wherein the subset of at least one plant comprises more than one plant, and wherein determining whether the mount of the particular metabolite is within the target range comprises determining whether a statistical measure of all measured amounts of the metabolite is within the target range.

3. The method of claim 1 wherein the particular metabolite is ethylene, and wherein step (e) comprises:
(e)(i) if the amount of ethylene is below the target range:
increasing the amount of CO₂ being infused into the CO₂-infused water;
decreasing the amount of O₂ being infused into the O₂-infused water; and
(e)(ii) if the amount of ethylene is above the target range:
decreasing the amount of CO₂ being infused into the CO₂-infused water;
increasing the amount of O₂ being infused into the O₂-infused water.

4. The method of claim 1 wherein the particular metabolite is vitamin C, and wherein step (e) comprises:
(e)(i) if the amount of vitamin C is below the target range:
increasing the amount of CO₂ being infused into the CO₂-infused water;
decreasing the amount of O₂ being infused into the O₂-infused water.

5. The method claim 1 wherein measuring an amount of a particular metabolite within a subset of at least one plant of the crop comprises measuring the amount of metabolite present directly.

6. The method claim 1 wherein measuring an amount of a particular metabolite within a subset of at least one plant of the crop comprises measuring the amount of metabolite present indirectly.

7. The method of claim 6 wherein measuring the amount of the metabolite indirectly comprises measuring an amount of mRNA associated with production of the metabolite.
